(19) United States
(12) Patent Application Publication
(10) Pub. No.: US 2006/0263016 A1
(43) Pub. Date: Nov. 23, 2006

(54) Method and apparatus for fusion splicing optical fibers

(75) Inventors: Robert G. Wiley, Frankfurt, KY (US); Donald Grasso, Franklin, TN (US); Steven A. Valle, Nashville, TN (US); Roberto A. Rivera, Fanklin, TN (US); Jared Meitzler, Spring Hill, TN (US); Clyde Troutman, Spring Hill, TN (US)

Correspondence Address: ECKERT SEAMANS CHERIN & MELLOTT, 600 GRANT STREET, 44TH FLOOR, PITTSBURGH, PA, 15219, US

(73) Assignee: 3SAE Technologies, Inc., Franklin, TN (US)

(21) Appl. No.: 11/436,335

(22) Filed: May 18, 2006

Related U.S. Application Data
(60) Provisional application No. 60/682,105, filed on May 18, 2005.

(51) Int. Cl. G02B 6/255

(52) U.S. Cl. 385/96

(57) ABSTRACT

An apparatus for fusion splicing optical fibers includes an airtight enclosure, a vacuum pump for evacuating the enclosure, first and second electrodes positioned within the enclosure, and a power source separate from an external to the enclosure for applying a voltage to the first electrode for generating an arc between the electrodes that is used to splice the first and second optical fiber portions together. Also, a method of fusion splicing optical fibers includes receiving first and second fiber portions within an airtight enclosure, evacuating the airtight enclosure, and applying a voltage to a first electrode within the enclosure from a source located separate from and external to the enclosure to cause the generation of an arc between the first electrode and a second electrode within the enclosure that is used to splice the first and second optical fiber portions together.

### CROSS-REFERENCE TO RELATED APPLICATION

The present application claims the benefit of U.S. Provisional Application No. 60/682,105, entitled “Method and Apparatus for Fusion Splicing Optical Fibers,” which was filed on May 18, 2005.

### BACKGROUND OF THE INVENTION

1. Field of the Invention

The present invention relates to the preparation of optical fibers, and in particular to a method and apparatus for fusion splicing optical fibers.

2. Description of the Prior Art

Fiber optic cables are widely used in modern optical devices and optical communications systems. Optical fibers are strands of glass fiber processed so that light beams transmitted through the glass fiber are subject to total internal reflection wherein a large fraction of the incident intensity of light directed into the fiber is received at the other end of the fiber. Optical fibers typically consist of a cylindrical core made of a first glass that is position inside a cylindrical casing made of another glass, wherein the refractive index of the second, outer glass is slightly lower than the refractive index of the first, inner glass. In addition, optical fibers are usually coated with one or more protective layers, for example a polymer coating made of acrylate or polyimide, in order to protect the surface of the fiber from chemical or mechanical damage. The optical fibers and coating layer may be made with varying dimensions, depending upon their intended use and the manufacturer.

In many applications, the optical fibers must be many kilometers long, and it is therefore often necessary to splice two shorter lengths of optical fiber together to form a longer optical fiber. In addition, the need to splice optical fibers also arises when an existing length of fiber breaks and must be repaired, or when an apparatus such as an amplifier must be incorporated into a length of fiber.

A number of techniques have been developed for splicing optical fibers. One known method is mechanical splicing, wherein the two ends to be spliced are held together with a splint. Mechanical splicing, however, produces splices that are often unreliable, both in terms of physical connection and optical performance, and is therefore not appropriate and/or effective in many applications. Another, more effective method of splicing optical fibers is known as fusion splicing. In fusion splicing, the two ends of fiber to be joined are melted together, yielding a virtually flawless splice. Fusion splicing has significant advantages over mechanical splicing, such as lower loss, higher mechanical strength, longer (twenty years or more) reliability, lower cost, and the ability to function over an extreme operational temperature range. The predominant and most effective method of fusion splicing utilizes an electrical arc to generate the extreme temperatures that are required to melt the two fiber ends together. A number of different fusion splicers are commercially available from various vendors.

Optical fibers are used in a number of different space constrained and/or hazardous environments, such as, for example, beneath many large cities in, for example, underground sewer systems, in oil wells, inside large network switches, and in operational, fueled aircrafts. These environments present two main problems when an optical fiber breaks and must be repaired. First, because of the small spaces in which the optical fibers reside, it is impractical or impossible to use the relatively large and bulky fusion splicing equipment that is currently commercially available to repair breaks in fibers in situ. Second, combustible vapors are often present in many of these environments, thereby making it prohibitively dangerous to use an electrical arc to fusion splice two fiber ends without removing the fiber portions from the environment. As a result, inconvenient and often difficult measures must be taken to repair optical fibers in these environments.

For example, in the case of optical fibers laid through sewers and other underground networks, an environment that is both space constrained and hazardous, splicing is currently accomplished by bringing the two ends of the optical fiber to the surface through a manhole cover and into a splice trailer where they are spliced using currently available splicing equipment. As will be appreciated, this process is logistically difficult and requires a significant amount of fiber slack.

Another environment that is both space constrained and hazardous is today's modern aircraft, which typically include significantly more optical fiber than ever before due to the prevalence of optical sensors and the need for high speed data transfer, security and reliability. The optical fiber is typically routed throughout the aircraft and can be difficult to reach when maintenance is required. If a fiber breaks, there are basically two options for repair. The first approach consists of a significant disassembly of the aircraft to remove the damaged fiber and install a new or repaired one. This effort, combined with reassembly and testing, can consist of hundreds of man-hours. The second approach involves in situ splicing of the damaged fiber. However, as described above, mechanical splicing is not sufficiently reliable, and, due to the presence of jet fuel, in situ fusion splicing is extremely dangerous.

Thus, there is a need for a fusion splicing method and apparatus the may be safely and conveniently used in space constrained and/or hazardous environments.

### SUMMARY OF THE INVENTION

In one embodiment, the invention relates to an apparatus for fusion splicing optical fibers. The apparatus includes an airtight enclosure that is structured to receive a first optical fiber portion and a second optical fiber portion that are to be spliced together. The apparatus also includes a vacuum pump operatively connected to the airtight enclosure for selectively evacuating the airtight enclosure and first and second electrodes positioned within the airtight enclosure. Finally, in this embodiment, the apparatus includes a power source located separate from and external to the airtight enclosure. The power source is operatively coupled, such as through a cable assembly, to at least the first electrode for applying a voltage to the first electrode to generate an arc between the first electrode and the second electrode. The arc generates a plasma which is used to splice the first and second optical fiber portions together.

The apparatus may include a fiber holding mechanism within the airtight enclosure for holding the first and second optical fiber portions. Preferably, the fiber holding mechanism is selectively movable to a location within the airtight enclosure wherein the ends of the first and second optical fiber portions are within or in proximity to a plasma region (i.e., the region in which the plasma is generated). In addition, the apparatus may also include a gas source external to the airtight enclosure for selectively introducing an inert gas, such as nitrogen or argon, into the airtight enclosure. The apparatus may also include one or more sensors located within the airtight enclosure for sensing at least one of the presence of or a level of one or more gasses within the airtight enclosure. Preferably, the one or more sensors sense at least one of the presence of or a level of one or more combustible gasses within the airtight enclosure. The apparatus may also include control electronics separate from an external to the airtight enclosure. In such an embodiment, the output of the one or more sensors is provided to the control electronics, which are adapted to determine whether the level of combustible gasses within the airtight enclosure is at or below a predetermined safe limit. Also, a camera may be provided within the airtight enclosure for capturing images of the fusion splicing process. The images are transmitted to and displayed at a location separate from and external to the airtight enclosure.

In another embodiment, the invention relates to a method of fusion splicing optical fibers. The method includes receiving a first optical fiber portion and a second optical fiber portion to be spliced together within an airtight enclosure and evacuating the airtight enclosure following the receiving step. The method also includes applying a voltage to a first electrode located within the airtight enclosure from a source located separate from an external to the airtight enclosure. The voltage causes the generation of an arc between the first electrode and a second electrode located within the airtight enclosure, and the arc creates a plasma that is used to splice the first and second optical fiber portions together. In one particular embodiment, the method further includes determining whether a level of each of one or more combustible gasses within the airtight enclosure is at or below a predetermined level prior to the applying step. In this embodiment, the applying step is performed only if it is determined that the level of each of the one or more combustible gasses is at or below the predetermined level. The method may further include introducing a selected volume or one or more inert gasses into the airtight enclosure following the evacuating step and prior to the applying step. The method may further include determining whether a level of each of one or more combustible gasses within the airtight enclosure is at or below a corresponding predetermined level and determining whether at least a minimum positive pressure exists within the airtight enclosure prior to the applying step. In this embodiment, the applying step is performed only if it is determined that the level of each of the one or more combustible gasses is at or below the corresponding predetermined level and that at least the minimum positive pressure exists within the airtight enclosure.

The step of determining whether a level of each of one or more combustible gasses within the airtight enclosure is at or below a corresponding predetermined level may include determining whether a level of oxygen within the airtight enclosure is at or below a predetermined oxygen limit and/or whether a level of each of one or more other selected combustible gasses within the airtight enclosure is at or below a corresponding predetermined limit. The determining step may also include determining whether a level of each of the one or more inert gasses within the airtight enclosure is at or above a corresponding predetermined inert gas limit. In each case, the determining step or steps preferably includes obtaining a sample of the contents of the airtight enclosure and analyzing the sample at a location separate from an external to the airtight enclosure.

### BRIEF DESCRIPTION OF THE DRAWINGS

These and other advantages of the present invention will become readily apparent upon consideration of the following detailed description and attached drawings, wherein:

FIG. 1 is a block diagram of a fusion splicing apparatus according to an embodiment of the present invention;

FIG. 2 is a flowchart illustrating the method of operation of the fiber splicing apparatus shown in FIG. 1 according to the present invention; and

FIG. 3 is a flowchart illustrating one particular embodiment of the method shown in FIG. 2.

### DESCRIPTION OF THE PREFERRED EMBODIMENTS

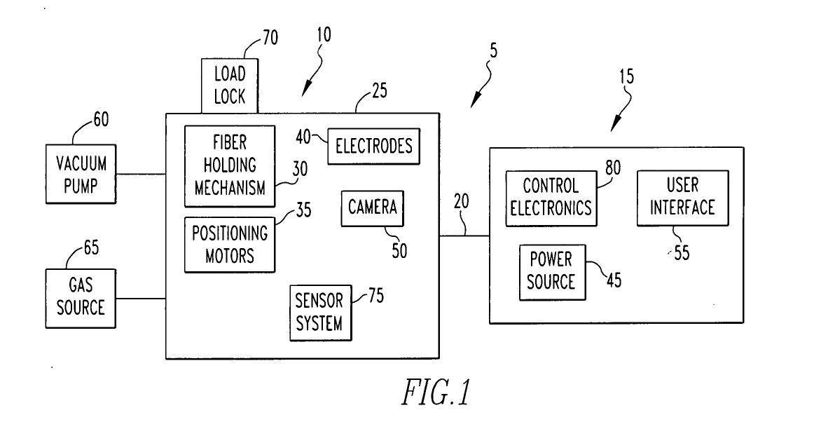

FIG. 1 is a block diagram of a fusion splicing apparatus 5 according to one embodiment of the present invention. As seen in FIG. 1, the fusion splicing apparatus 5 includes a splice head 10 and support hardware 15 that are connected to one another by cable assembly 20. Fusion splicing apparatus 5 is particularly well adapted for use in space constrained and/or hazardous environments because, as described in detail below, the splice head 10 (which includes the components for generating the electrical splicing arc) is physically separated from the support hardware 15, and the splice head 10 is isolated from the surrounding environment.

Splice head 10 includes an airtight enclosure 25 made of a material such as, without limitation, metal or plastic. Airtight enclosure 25 may take on any of a number of shapes, such as, without limitation, a rectangular, square or spherical shape. Splice head 10 is provided with a fiber holding mechanism 30 for holding the ends of the optical fiber portions that are to be spliced to one another. The fiber holding mechanism 30 includes known fiber holding devices such as V-grooves and clamps. One or more positioning motors 35, such as one or more stepper motors, are provided within the airtight enclosure 25 and are coupled to the fiber holding mechanism 30 to enable the fiber holding mechanism 30, and thus the fiber ends it holds, to be selectively positioned within the airtight enclosure 25.

Airtight enclosure 25 also includes first and second electrodes 40. The first and second electrodes 40 are adapted to produce an electrical arc therebetween in response to having a high voltage applied thereto (by way of cable assembly 20) by the power source 45 that is provided as part of the support hardware 15. The electrical arc generates a plasma in the area between the first and second electrodes 40. The intense heat generated by the plasma may, according to the present invention, and in the manner described in greater detail below, be used to fusion splice two pieces of optical fiber when they are caused to be positioned within or sufficiently near the plasma by the fiber holding mechanism 30 and the positioning motors 35. A camera 50, such as a video camera, is also provided within the airtight enclosure 25. The camera 50 provides images, by way of cable assembly 20, to a user interface 55 that preferably includes a display, such as an LCD, and an input device, such as a keypad. The images provided by the camera 50 enable a user of the fusion splicing apparatus 5 to observe in real time the positioning and splicing of optical fibers.

A vacuum pump 60 is operatively coupled to the airtight enclosure 25 to enable the airtight enclosure 25 to be selectively evacuated. A source 65 of an inert gas, such as nitrogen or argon, is also connected to the airtight enclosure 25 so that the airtight enclosure 25 may be selectively flooded with the inert gas. The airtight enclosure 25 is further provided with a load lock mechanism 70 for inserting the pieces of optical fiber to be spliced together into the airtight enclosure 25.

In addition, the airtight enclosure 25 includes a sensor system 75 that includes one or more sensors. For the reasons that are described below, sensor system 75 is adapted to do one or more of the following: (i) sense the presence of, and preferably the actual percentage of, oxygen that is present within the airtight enclosure 25, (ii) sense the presence of, and preferably the actual percentage of, one or more selected combustible vapors, such as those generated from jet fuel or those typically generated in an oil well environment, that are present within the airtight enclosure 25, (iii) sense the presence of, and preferably the actual percentage of, the inert gas from the source 65 that is present within the airtight enclosure 25, and (iv) sense the pressure within the airtight enclosure 25. Such sensor systems are widely known, and a number of systems suitable for use as sensor system 75 are commercially available.

As seen in FIG. 1, the support hardware 15 is physically separated from the splice head 10. The support hardware 15 includes the power source 45 which, as described above, provides the power to positioning motors 35, the first and second electrodes 40, and the camera 50, among other things, through the cable assembly 20. The user interface 55 is also provided as part of the support hardware 15 and enables a user to input information, such as control commands, into and receive information, such as images, from the fusion splicing apparatus 5. The support hardware 15 further includes control electronics 80 having a processing unit such as a microprocessor and an associated memory. The memory of the control electronics 80 includes a number of routines for controlling the operation of the splice head 10 as described herein.

According an aspect of the present invention, the splice head 10 is of a relatively small size as compared to existing fusion spicing equipment. Also, the cable assembly is of a length sufficient for the particular application in question. These factors allow the splice head 10 to be positioned and used in a space constrained environment, such as in an underground sewer or inside an aircraft, while the support hardware is positioned in a separate, preferably more spacious environment.

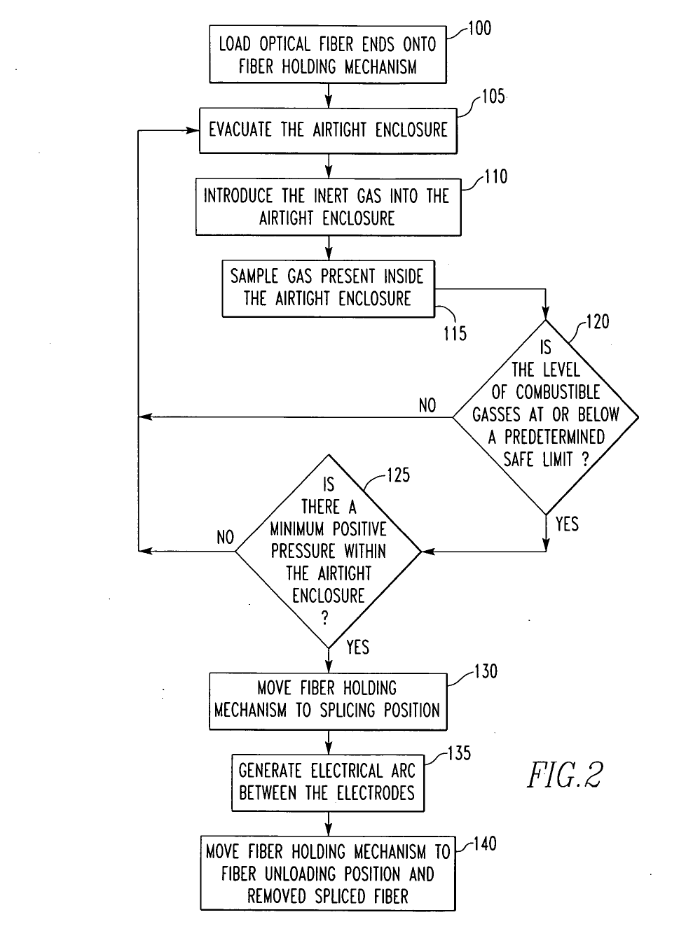

FIG. 2 is a flowchart illustrating the operation of the fiber splicing apparatus 5 according to one embodiment of the present invention. The method of operation begins at step 100, wherein the ends of the optical fiber portions to be spliced together are inserted into the airtight enclosure 25 and onto the fiber holding mechanism 30 through the load lock 70. Next, at step 105, the airtight enclosure 105 is evacuated using vacuum pump 60, meaning that the pressure within the airtight enclosure 105 is reduced to some suitable reduced level; an ideal vacuum is not required. A selected volume of inert gas, such as nitrogen or argon, is then introduced into the airtight enclosure from the gas source 65 as shown in step 110. At step 115, the sensor system 75 samples the gas that is present in the airtight enclosure 25. A determination is then made, at step 120, as to whether the level of combustible gasses, such as oxygen or any of one or more other selected combustible vapors, within the airtight enclosure 25 is at or below a predetermined safe limit. If the answer at step 120 is no, then the method returns to step 105, wherein the airtight enclosure is once again evacuated. If, however, the answer at step 120 is yes, then, at step 125, a determination is made as to whether a positive pressure exists within the airtight enclosure 25. If the answer at step 125 is no, the method once again returns to step 105. However, if the answer at stop 125 is yes, meaning that the environment within the airtight enclosure 25 is safe for the generation of an electrical arc, then, at step 130, the fiber holding mechanism 30 is moved to a splicing position, wherein the ends of the optical fiber portions held thereby are positioned within or sufficiently near the area between the first and second electrodes 40 in which a plasma will be generated by the electrical arc. The user is able to observe the positioning of the ends of the optical fiber portions by way of images generated by the camera 50 and displayed on the user interface 55. Next, at step 135, an electrical arc is generated between the first and second electrodes 40 for a predetermined time period, thereby creating a plasma between the first and second electrodes 40. As is known in the art, the plasma that is generated produces heat sufficient to fuse the ends of the optical fiber portions together. The electrical arc may be safely generated in this case because it is generated within the airtight enclosure 25 and because, at step 120, it has been determined that substantially only the inert gas, and not a dangerous level of any combustible gasses, is present within the airtight enclosure. The user is able to observe the fused ends of the optical fiber portions by way of images generated by the camera 50 and displayed on the user interface 55. After it has been determined, through observation, that the splicing is complete, the fiber holding mechanism 30 is, at step 140, moved to an unloading position within the airtight enclosure 25 and the spliced fiber is removed by the user.

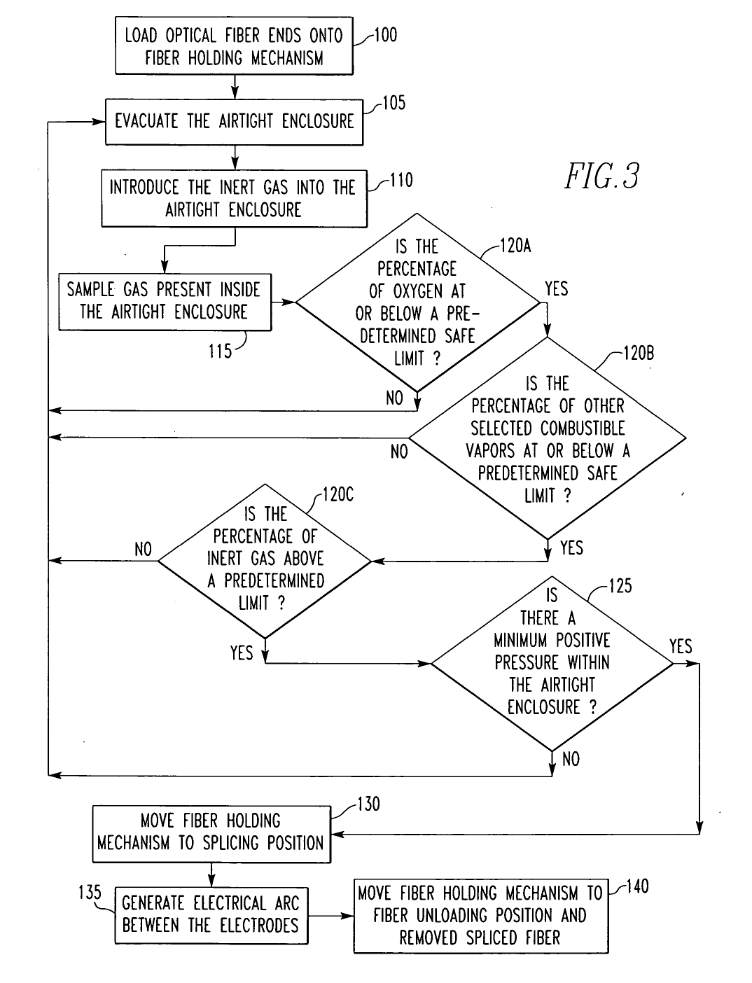

Step 120 shown in FIG. 2, namely the determination as to whether the percentage of combustible gasses within the airtight enclosure 25 is at or below a predetermined safe limit, may be preformed in a number of different manners. One particular embodiment is shown in FIG. 3, wherein step 120 includes three sub-steps, steps 120A, 120B and 120C (all other steps are as described in connection with FIG. 2). In particular, in step 120A, a determination is made, using the sensor system 75, as to whether the percentage of oxygen within the airtight enclosure 25 is below a predetermined safe limit. If the answer is no, then the method returns to step 105. If, however, the answer at step 120A is yes, then, at step 120B, a determination is made, using the sensor system 75, as to whether the percentage of one or more other selected combustible vapors within the airtight enclosure 25 is below a predetermined safe limit. If the answer is no, then the method returns to step 105. If, however, the answer at step 120B is yes, then, at step 120C, a determination is made, using the sensor system 75, as to whether the percentage of the inert gas within the airtight enclosure 25 is substantially equal to 100%. If the answer is no, the method returns to step 105. If the answer is yes, the method moves to strep 125. These sub-steps may be performed is any order. In addition, other variations are also possible. For example, other embodiments of the method may include only one of steps 120A, 120B and 120C, or any two of steps 120A, 120B and 120C. Further, step 125 may be omitted in any of the described embodiments. The important point is that there is a determination that no combustible gasses, i.e., oxygen or other selected combustible vapors, are present in the airtight enclosure 25 before an electrical arc is generated.

Thus, the present invention provides a method and apparatus for fusion splicing optical fiber portions the may be safely and conveniently used in space constrained and/or hazardous environments such as, for example, underground sewer systems, in oil wells, inside large network switches, and in fueled aircrafts.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the claims that ultimately issue.

1. An apparatus for fusion splicing optical fibers, comprising:
an airtight enclosure, said airtight enclosure being structured to receive a first optical fiber portion and a second optical fiber portion to be spliced together;
a vacuum pump operatively connected to said airtight enclosure for selectively evacuating said airtight enclosure;
a first electrode and a second electrode positioned within said airtight enclosure; and
a power source located separate from and external to said airtight enclosure, said power source being operatively coupled to at least said first electrode for applying a voltage to said first electrode to generate an arc between said first electrode and said second electrode.

2. The apparatus according to claim 1, further comprising a fiber holding mechanism within said airtight enclosure for holding said first optical fiber portion and said second optical fiber portion.

3. The apparatus according to claim 2, wherein said arc generates a plasma in a plasma region within said airtight enclosure, and wherein said fiber holding mechanism is selectively moveable to a location within said airtight enclosure wherein an end of each of said first and second optical fiber portions is within or in proximity to said plasma region.

4. The apparatus according to claim 3, further comprising one or more positioning motors operatively connected to said fiber holding mechanism for selectively moving said fiber holding mechanism.

5. The apparatus according to claim 1, further comprising a gas source external to said airtight enclosure for selectively introducing an inert gas into said airtight enclosure.

6. The apparatus according to claim 1, further comprising one or more sensors within said airtight enclosure for sensing at least one of the presence of or a level of one or more gasses within said airtight enclosure.

7. The apparatus according to claim 6, wherein one or more of said one or more sensors sense at least one of the presence of or a level of one or more combustible gasses within said airtight enclosure.

8. The apparatus according to claim 7, further comprising control electronics separate from and external to said airtight enclosure, wherein an output of said one or more sensors is provided to said control electronics, and wherein said control electronics are adapted to determine whether said level of one or more combustible gasses is at or below a predetermined safe limit.

9. The apparatus according to claim 1, further comprising a camera within said airtight enclosure, wherein images obtained by said camera are transmitted to and displayed at a location separate from and external to said airtight enclosure.

10. A method of fusion splicing optical fibers, comprising:
receiving a first optical fiber portion and a second optical fiber portion to be spliced together within an airtight enclosure;
evacuating said airtight enclosure; and
applying a voltage to a first electrode located within said airtight enclosure from a source located separate from and external to said airtight enclosure, said voltage causing the generation of an arc between said first electrode and a second electrode located within said airtight enclosure, said arc creating a plasma used to splice said first and second optical fiber portions together.

11. The method according to claim 10, further comprising determining whether a level of each of one or more combustible gasses within said airtight enclosure is at or below a corresponding predetermined level prior to said applying step, and performing said applying step only if it is determined that the level of said each of one or more combustible gasses is at or below said corresponding predetermined level.

12. The method according to claim 10, further comprising introducing a selected volume of one or more inert gasses into said airtight enclosure following said evacuating step and prior to said applying step.

13. The method according to claim 12, further comprising determining whether a level of each of one or more combustible gasses within said airtight enclosure is at or below a corresponding predetermined level and whether at least a minimum positive pressure exists within said airtight enclosure prior to said applying step, and performing said applying step only if it is determined that the level of said each of one or more combustible gasses is at or below said corresponding predetermined level and that at least said minimum positive pressure exists within said airtight enclosure.

14. The method according to claim 10, wherein said plasma is generated within a plasma region, said method further comprising moving an end of each of said first and second optical fiber portions to a location within or in proximity to said plasma region prior to said applying step.

15. The method according to claim 11, wherein said determining step comprises determining whether a level of oxygen within said airtight enclosure is at or below a predetermined oxygen limit.

16. The method according to claim 15, wherein said determining step further comprises determining whether a level of each of one or more other selected combustible gasses with said airtight enclosure is at or below a corresponding predetermined limit.

17. The method according to claim 11, further comprising introducing a selected volume of one or more inert gasses into said airtight enclosure following said evacuating step and prior to said applying step, wherein said determining step comprises determining whether a level of each of said one or more inert gasses within said airtight enclosure is at or above a corresponding predetermined inert gas limit.

18. The method according to claim 11, wherein said determining step comprises obtaining a sample of the contents of said airtight enclosure and analyzing said sample at a location separate from and external to said airtight enclosure.
